(19) United States
(12) Patent Application Publication
(10) Pub. No.: US 2010/0064090 A1
(43) Pub. Date: Mar. 11, 2010

(54) CWUSB Interface

(76) Inventors: Iain Thomas Learmonth, N. Waltham, Basingstoke (GB); Musa Ibrahim Kakish, Anaheim, CA (US)

Correspondence Address: LAMBERT & ASSOCIATES, P.L.L.C., 92 STATE STREET, BOSTON, MA, 02109-2004, US

(21) Appl. No.: 12/283,010

(22) Filed: Sep. 9, 2008

(51) Int. Cl. G06F 13/00

(52) U.S. Cl. 710/316

(57) ABSTRACT

A CWUSB interface 1 is shown installed in a printer 2. The interface allows a computer 3 to send print data to the printer, either wirelessly or in a hard wired manner, for which the computer has an auxiliary communication card 4 having an aerial 5 and the usual Type A USB socket 6. A cable 7 is provided for wired connection.

The interface 1 has a WUSB controller 8 with an aerial 9 connected to it, which can co-operate with the aerial 5. The interface also has a Type B USB socket 10 for wired connection. A peripheral device controller 11 is connected to either of the socket 10 or the WUSB controller 8 via a pair of switches 12,14. These are under control of the WUSB controller. Being a wireless device, it can communicate with the computer only if the interface is associated with the computer, that is to say the computer as its host has recorded the full ID of the interface, the interface has recorded the full ID of the host and the host and interface have exchanged encryption keys. This is known as association. Further, the host can only communicate data to the interface when the host has enumerated the interface, that is given the interface the address to which to refer for data to be sent to it. Association and enumeration are to of course standard routines.

### BACKGROUND OF THE INVENTION

1. Field of the Invention

The present invention relates to a USB interface.

2. Description of the Related Art

A CWUSB (Certified Wireless Universal Serial Bus) interface is a device whereby a suitably equipped computer can communicate wirelessly with a peripheral device incorporating the interface. This is of particular advantage where the computer is a portable, lap top computer.

CWUSB data communication is very convenient, but is restricted in data transmission speed. Therefore printing of high definition color documents can take longer using CWUSB than hard wiring.

### SUMMARY OF THE INVENTION

The object of the present invention is to provide CWUSB interface that can be used wirelessly or in a wired mode at will.

According to the invention there is provided a CWUSB interface for passing USB data in a wired or wireless manner from a host to a downstream device, the interface having:
a controller for the downstream device,
a WUSB controller including an aerial for wireless sending and receiving of USB data,
a USB socket for wired transfer of USB data to or from the interface and
switch means under the control of the WUSB controller for switching passage of data to or from the downstream device controller via either the socket in “wired mode” or via the aerial in “wireless mode”, wherein the WUSB controller is adapted and arranged to:
set the switch means to wired mode initially (regardless of whether a wired connection exists) and after a time period either to:
   remain in wired mode if during the time period enumeration has occurred or to
   switch to wireless mode if enumeration has not occurred.

Preferably, the WUSB is adapted and arranged to perform an association routine on enumeration in wired mode, if the CWUSB interface has not been associated with the host previously. The association can occur during the time period or thereafter.

The arrangement provides that (i.) on connection of the CWUSB interface for the first time—in the wired mode for association to take place—the association occurs automatically, (ii.) on any subsequent wired connection wired data transmission occurs and (iii.) on any subsequent wireless connection, i.e. power up of the CWUSB interface, association has already occurred and wireless connection can proceed.

Preferably, the USB socket is a type B USB connector.

Preferably, the CWUSB interface is incorporated in the downstream device which is to be controlled by the downstream device controller. In this case, the downstream device is a peripheral device and the downstream device controller is a peripheral device controller. Typically the peripheral device is a printer or a scanner or a memory device.

Alternatively the CWUSB interface can be a stand alone device including a second USB socket for wired transfer of USB data to or from a downstream device via the downstream device controller in the interface. Normally the USB socket is a type A USB socket.

The CWUSB interface can be a hub having a plurality of type A USB connectors for onwards connection in a wired manner to a plurality of peripheral devices.

In one embodiment, the WUSB controller has a dual role, combined host and device, Phy port and the switch means has two switches connected to allow:
series connection of the switches for connection of the WUSB controller to the USB socket for association of the controller with the host, with the common point of the one switch being connected to the USB socket and the common point of the other switch being connected to the dual role Phy point;
switching of one switch from the switches' association state to allow connection of the USB socket to the downstream device controller, with the other switch remaining unswitched, for wired mode operation; and
switching of the other switch from the switches' association state to allow connection of the USB socket to the downstream device controller, with the one switch remaining unswitched.

In another embodiment, the WUSB controller has two, host and device, Phy ports and the switch means has two switches connected to allow:
connection of the device Phy port to the USB socket for association via one switch, the common point of the one switch being connected to the USB socket, with the other connecting the downstream device controller to the host Phy port which is inactive during association, the common point of the other switch being connected to the peripheral device controller;
switching of the one switch to be open circuit and the other switch to the USB socket, for wired mode operation; and
switching of the one switch to be open circuit and the other switch to host Phy point, for wireless mode operation.

### BREIF DESCRIPTION OF THE DRAWINGS

To help understanding of the invention, a specific embodiment thereof will now be described by way of example and with reference to the accompanying drawings, in which:

FIG. 1 is a diagrammatic view of a CWUSB interface of the invention in a printer and connected by cable to a computer;

FIG. 2 is a flow chart showing initial operation of the interface of FIG. 1;

FIG. 3 is a diagrammatic view of a second CWUSB interface of the invention; and

FIG. 4 a flow chart showing initial operation of the interface of FIG. 3.

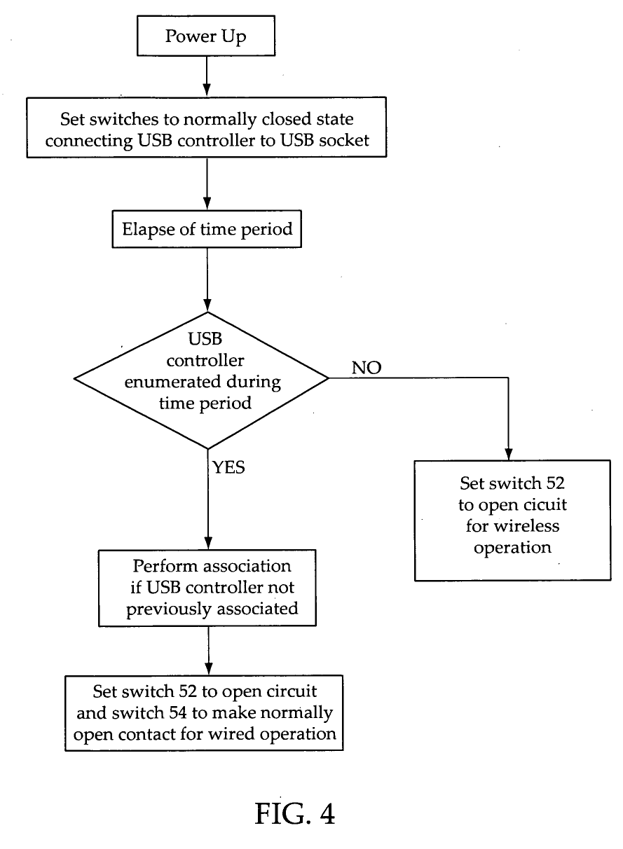

### DESCRIPTION OF THE PREFERRED EMBODIMENT

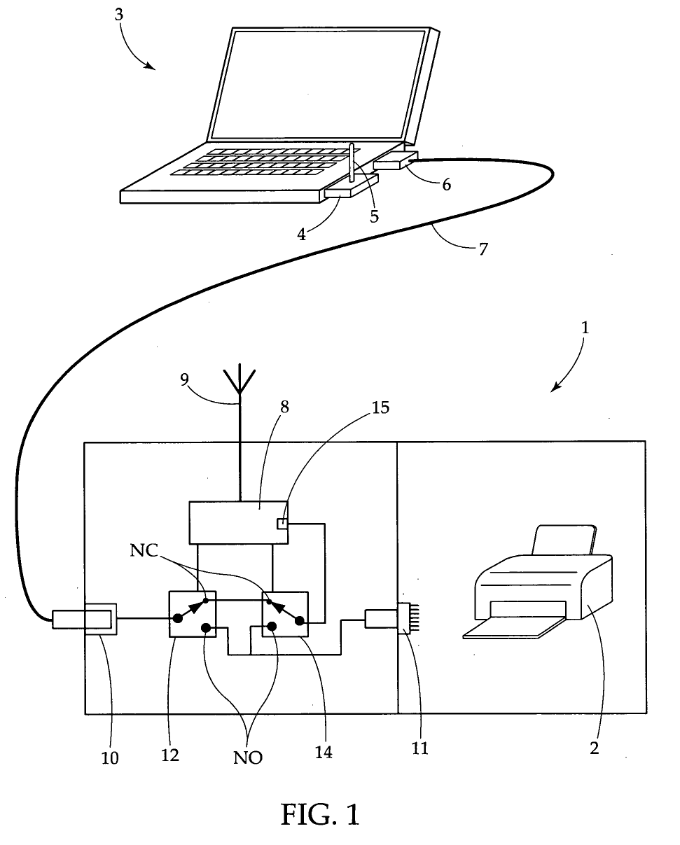

Referring to FIG. 1, a CWUSB interface 1 is shown installed in a printer 2. The interface allows a computer 3 to send print data to the printer, either wirelessly or in a hard wired manner, for which the computer has an auxiliary communication card 4 having an aerial 5 and the usual Type A USB socket 6. A cable 7 is provided for wired connection.

The interface 1 has a WUSB controller 8 with an aerial 9 connected to it, which can co-operate with the aerial 5. The interface also has a Type B USB socket 10 for wired connection. A peripheral device controller 11 is connected to either of the socket 10 or the WUSB controller 8 via a pair of switches 12 and 14. These are under control of the WUSB controller. Being a wireless device, it can communicate with the computer only if the interface is associated with the computer, that is to say the computer as its host has recorded the full ID of the interface, the interface has recorded the full ID of the host and the host and interface have exchanged encryption keys. This is known as association. Further, the host can only communicate data to the interface when the host has enumerated the interface, that is given the interface the address to which to refer for data to be sent to it. Association and enumeration are to of course standard routines.

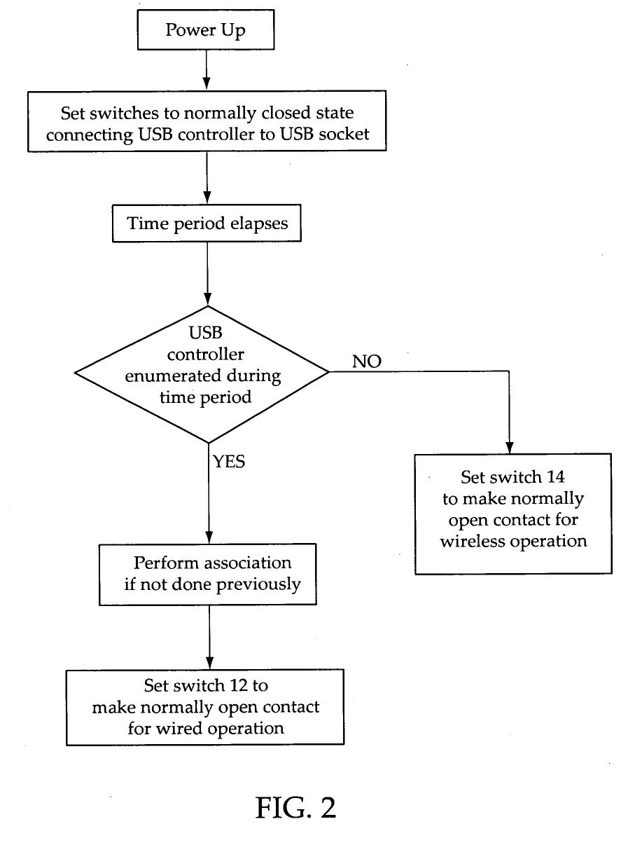

With reference to FIG. 2, the WUSB controller is programmed to set both switches to their normally closed state shown in FIG. 1 on power up of the interface. This state of the switches is maintained for a period of say 15 seconds. During this period, the WUSB controller expects enumeration to occur. It does not operate wirelessly. If enumeration does occur, this indicates to the controller that its in wired connection to the host, that is via the cable 7 and the sockets 6 and 10. Enumeration can occur without association. However, if interface has not been previously associated, it instigates the association routine after enumeration, the USB controller having set itself to association mode. This can occur within the time period or after it and is primarily triggered by enumeration by the wired connection.

After the association, the interface is ready for wired data connection between the computer and the printer. For this, the normally open contact is made in the switch 12. The state of the switch 14 is not changed.

If no wired connection is present, enumeration does not occur. This triggers the WUSB controller to switch to operate in wireless mode. This it can do only if association has previously occurred. Provided that this is the case, the switch 14 is changed to make the normally open contact. The state of the switch 12 is not changed.

This operation is shown the flow diagram of FIG. 2.

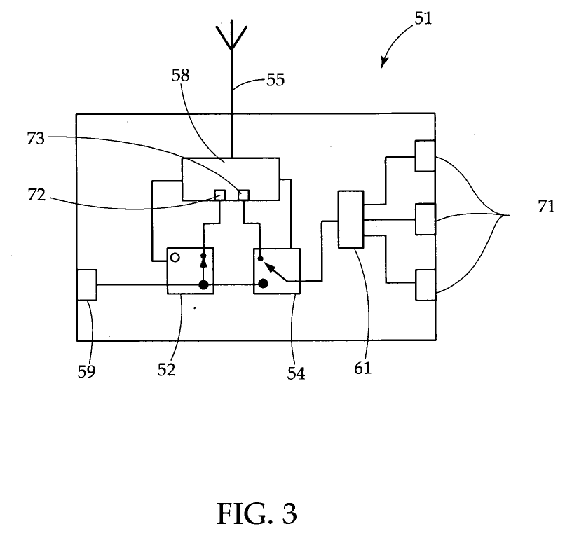

Turning now to FIG. 3, the CWUSB interface 51 thereshown is configured as a hub, able to receive or send USB data wirelessly via its aerial 55 or in a wired manner via its Type B USB socket 59. The data is passed on or collected via any of three Type A USB sockets 71, connected to a downstream device controller 61. This can be connected directly to the socket 59 via two switches 52 and 54, themselves under the control of a WUSB controller 58, to which the aerial is connected. Whereas the above described WUSB controller 8 has dual role Phy port 15, such as an OTG—On-The-Go—port, able to operate as both a device and a host, the WUSB controller 58 has two Phy ports 72, 73 operating as a device and a host respectively.

On power-up, the USB controller 58 does not operate wirelessly and switches the switch 54 to connect the downstream device controller to the host Phy 73 via the normally closed contact. No signal is passed since the WUSB controller disables this. Further on power-up the switch 52 is controlled connect the USB socket to the device Phy 72, whereby the controller can perform enumeration and association if this has not previously occurred. After elapse of the pre-determined time period, if enumeration has occurred, the controller switches switch 52 to open circuit and switch 54 to its normally open condition. Data can now pass from the socket to the downstream device controller in wired mode, bypassing the WUSB controller. If enumeration has not occurred, nor has association previously occurred, the interface remains passive. However in the absence of enumeration, but where association has previously occurred, the controller again switches the switch 52 to be open circuit and it maintains the normally close condition of switch 54. The interface operates wirelessly with the WUSB controller and the downstream device controller connected for passage of data.

In this embodiment, the function of the downstream device controller is merely to receive and pass on data.

It will be understood that although the switches have been described above as if they have physical contacts, which are normally open and normally closed, they will be transistor switches with the equivalent of normally open and normally closed contacts.

1. A CWUSB interface for passing USB data in a wired or wireless manner from a host to a downstream device, the interface having:
a controller for the downstream device,
a WUSB controller including an aerial for wireless sending or receiving of USB data,
a USB socket for wired transfer of USB data to or from the interface and
switch means under the control of the WUSB controller for switching passage of data to or from the downstream device controller via either the socket in “wired mode” or via the aerial in “wireless mode”,
wherein the WUSB controller is adapted and arranged to:
set the switch means to wired mode initially (regardless of whether a wired connection exists) and after a time period either to:
remain in wired mode if during the time period enumeration has occurred or to
switch to wireless mode if enumeration has not occurred.

2. A CWUSB interface according to claim 1, wherein the WUSB is adapted and arranged to perform an association routine on enumeration in wired mode, if the CWUSB interface has not been associated with the host previously.

3. A CWUSB interface according to claim 2, wherein the WUSB is adapted and arranged to perform the association during the said time period.

4. A CWUSB interface according to claim 3, wherein the WUSB is adapted and arranged to perform the association after the said time period.

5. A CWUSB interface according to claim 1, wherein the USB socket is a type B USB socket.

6. A CWUSB interface according to claim 1, wherein the CWUSB interface is incorporated in the downstream device which is to be controlled by the downstream device controller.

7. A CWUSB interface according to claim 1, wherein the downstream device is a peripheral device.

8. A CWUSB interface according to claim 7, wherein the peripheral device is a printer.

9. A CWUSB interface according to claim 7, wherein the peripheral device is a scanner.

10. A CWUSB interface according to claim 7, wherein the peripheral device is a memory device.

11. A CWUSB interface according to claim 1, wherein the CWUSB interface is a stand alone device including a second USB socket for wired transfer of USB data to or from a downstream device via the downstream device controller in the interface.

12. A CWUSB interface according to claim 11, wherein the USB socket is a type A USB socket.

13. A CWUSB interface according to claim 1, wherein the CWUSB interface is a hub having a plurality of type A USB connectors for onwards connection in a wired manner to a plurality of peripheral devices.

14. A CWUSB interface according to claim 1, wherein the WUSB controller has a dual role, combined host and device, Phy port and the switch means has two switches connected to allow:
series connection of the switches for connection of the WUSB controller to the USB socket for association of the controller with the host, with the common point of the one switch being connected to the USB socket and the common point of the other switch being connected to the dual role Phy point;
switching of one switch from the switches' association state to allow connection of the USB socket to the downstream device controller, with the other switch remaining unswitched, for wired mode operation; and
switching of the other switch from the switches' association state to allow connection of the USB socket to the downstream device controller, with the one switch remaining unswitched.

15. A CWUSB interface according to claim 1, wherein the WUSB controller has two, host and device, Phy ports and the switch means has two switches connected to allow:
connection of the device Phy port to the USB socket for association via one switch, the common point of the one switch being connected to the USB socket, with the other connecting the downstream device controller to the host Phy port which is inactive during association, the common point of the other switch being connected to the downstream device controller;
switching of the one switch to be open circuit and the other switch to the USB socket, for wired mode operation; and
switching of the one switch to be open circuit and the other switch to host Phy point, for wireless mode operation.
